(19) United States
(12) Patent Application Publication
(10) Pub. No.: US 2005/0102385 A1
(43) Pub. Date: May 12, 2005

(54) System and associated terminal, method and computer program product for controlling storage of content

(75) Inventors: Ahti Muhonen, Hirvihaara (FI); Antti-Pentti Vainio, Espoo (FI); Ari Hannikainen, Turku (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/690,656

(22) Filed: Oct. 22, 2003

(51) Int. Cl. G06F 15/173

(52) U.S. Cl. 709/223

(57) ABSTRACT

A system for controlling storage of content in memory includes a network entitiy, such as a digital broadcast transmitter, a digital broadcast receiver or a terminal. The network entity includes an expiration control application capable of receiving a status of a at least one piece of content stored in memory of a terminal. Each piece of content is associated with at least one parameter including at least a client expiration time and/or a deletion priority value. Based upon the status and the associated parameter(s), then, the expiration control application can control storage of content in memory of the terminal.

### FIELD OF THE INVENTION

The present invention generally relates to systems and methods for controlling storage of content and, more particularly, to systems and associated terminals, methods and computer program products for controlling storage of content in terminals.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. Although the increased bit rates of 3G systems widen the possibilities for providing digital services.

The increased bit rates of 3G systems provide adequate performance for delivering high quality digital audio and acceptable quality moving image clips. However, at these transfer rates it may be difficult to handle exceedingly high data intensive tasks such as delivering high quality full-motion video and transferring very large data files to mobile terminals. In this regard, attempts at downloading large data files may lead to inconveniently long downloading times that can be undesirably costly for users. For this and other reasons, alternative broadband delivery techniques have been investigated that could provide a practical solution for high data intensive tasks in terms of lower cost and convenience for the users involved.

One such delivery technique that has shown promise is Digital Video Broadcasting (DVB). In this regard, DVB-T, which is related to DVB-H (handheld), DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently transmitting large amounts of data over a broadcast channel to a high number of users at a lower cost, when compared to data transmission through mobile telecommunication networks using, e.g., 3G systems. DVB-T has also proven to be exceptionally robust in that it provides increased performance in geographic conditions that would normally affect other types of transmissions, such as the rapid changes of reception conditions, and hilly and mountainous terrain.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

The combined use of mobile telecommunications with a broadband delivery technique such as DVB-T has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. Furthermore, DVB-T is a cross platform standard that is shared by many countries thereby making frequency compatibility and roaming less of an issue. The combination of mobile telecommunication and a relatively very low cost digital broadband delivery techniques provides the possibility of interactive services such as uni-directional and bi-directional services such as audio and video streaming (e.g., TV, radio, etc.), file downloads and advanced gaming applications, etc.

However, there are some challenges with developing the mobile terminals needed for combined use with digital broadband data broadcast techniques (e.g., DVB-T). In this regard, mobile terminals are generally capable of storing only a limited amount of data. In the development of DVB-T, it was envisioned that signal reception would be mainly carried out by set-top boxes in generally stationary environments where data storage issues were largely unimportant. The ability of digital broadband data broadcast techniques to deliver a large amount of data at a high bit rate to a mobile handheld device, however, can place a heavy storage capacity burden on the terminal. This is especially the case when multiple pieces of content are delivered to the mobile terminal, with the user desiring to receive one or more pieces of content at different times for viewing at a time subsequent to receiving the content. In mobile terminals that also operate as telecom devices, content storage is a particularly important issue since users expect sufficiently reasonable storage capacity for necessary communication purposes which they expect to be available.

### SUMMARY OF THE INVENTION

In light of the foregoing background, embodiments of the present invention provide a system and associated terminal, method and computer program product for controlling storage of content, particularly for mobile terminals that are operable with mobile telecommunication and digital broadcast networks. To facilitate control of content storage in accordance with embodiments of the present invention, content includes a set of one or more parameters. For example, each piece of content can include a server expiration time, a client expiration time and/or a deletion priority value. Based upon the server expiration time, client expiration time and/or deletion priority value, then, content can be maintained in, or deleted from, memory, such as memory of a terminal. In this regard, a terminal can be capable of receiving a large amount of data or content at a high bit rate with a reduced burden on the storage capacity of the terminal, even when multiple pieces of content are delivered to the mobile terminal, with the user desiring to view the different pieces of content at different times.

According to one aspect of the present invention, a system is provided for controlling storage of content in memory. The system includes network entitiy, such as a digital broadcast transmitter, a digital broadcast receiver or a terminal. The network entity comprises an expiration control application capable of receiving a status of a at least one piece of content stored in memory of a terminal. Each piece of content is associated with at least one parameter including at least a client expiration time and/or a deletion priority value. Based upon the status and the associated parameter(s), then, the expiration control application can control storage of content in memory of the terminal.

More particularly, the expiration control application can be capable of determining if memory of the terminal has sufficient storage capacity for at least one subsequent piece of content. And if memory does not have sufficient storage capacity, the expiration control application can instruct the terminal to delete at least one piece of content based upon the deletion priority value of each piece of content stored in memory of the terminal. In this regard, the expiration control application can be capable of determining at least one piece of content having an exceeded client expiration time. Thereafter, the expiration control application can identify a piece of content having a highest deletion priority value from the piece(s) of content having an exceeded client expiration time, and instruct the terminal to delete the identified piece of content.

The expiration control application can be capable of repeatedly identifying a piece of content, and instructing the terminal to delete the identified piece of content, until either (a) memory of the terminal has sufficient storage capacity for the at least one subsequent piece of content, or (b) each piece of content having an exceeded client expiration time has been identified and deleted. However, in various instances memory of the terminal does not have sufficient storage capacity for at least one subsequent piece of content, and each of the piece(s) of content having an exceeded client expiration time has been identified and deleted. In such instances, the expiration control application can be further capable of identifying at least one piece of content having a highest deletion priority value from at least one piece of content remaining in memory of the terminal, and instructing the terminal to delete the identified at least one piece of content.

The network entity can be capable of storing at least one piece of content, where the parameter(s) further include a server expiration time. In addition to storing piece(s) of content, the network entity can be capable of sending at least one piece of content to the terminal. In embodiments such embodiments, the expiration control application can be further capable of monitoring the server expiration time of the piece(s) of content in memory of the network entity to determine if at least one piece of content has an exceeded server expiration time. Then, if at least one piece of content has an exceeded server expiration time, the expiration control application can instruct the network entity to delete the at least one piece of content having an expired server expiration time.

The system can further include a terminal capable of sending the status of the piece(s) of content stored in memory of the terminal such that the network entity can control the storage of content in memory of the terminal. The terminal can also be capable of associating each piece of content stored in memory of the terminal with at least one parameter. For example, the terminal can be capable of setting a deletion priority value for at least one piece of content. Additionally, or alternatively, the network entity can be capable of associating each piece of content stored in memory of the terminal with at least one parameter.

According to other aspects of the present invention, a terminal, method and computer program product are provided for controlling storage of content. Therefore, embodiments of the present invention provide a system and associated terminal, method and computer program product for controlling storage of content. The system and associated terminal, method and computer program product of embodiments of the present invention are capable of controlling storage of content, or more particularly the deletion of content, at the terminal and/or network entity based upon one or more parameters (e.g., server expiration, client expiration and/or deletion priority value) associated with each piece of content. As such, the terminal can be capable of receiving a large amount of data or content at a high bit rate with a reduced burden on the storage capacity of the terminal. Embodiments of the present invention can further reduce the burden on the storage capacity of the terminal even in instances in which multiple pieces of content are delivered to the mobile terminal, with the user desiring to view the different pieces of content at different times. Therefore, the system, and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of an entity capable of operating as a terminal, origin server, digital broadcast receiver and/or a digital broadcaster, in accordance with embodiments of the present invention;

FIG. 3 is a functional block diagram of a digital broadcast receiver, in accordance with one embodiment of the present invention;

FIG. 4 is a functional block diagram of the digital broadcaster, in accordance with one embodiment of the present invention;

FIG. 5 is a schematic block diagram of a mobile station that may operate as a terminal, according to embodiments of the present invention; and

FIG. 6 is a flowchart of a method of controlling storage of content in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

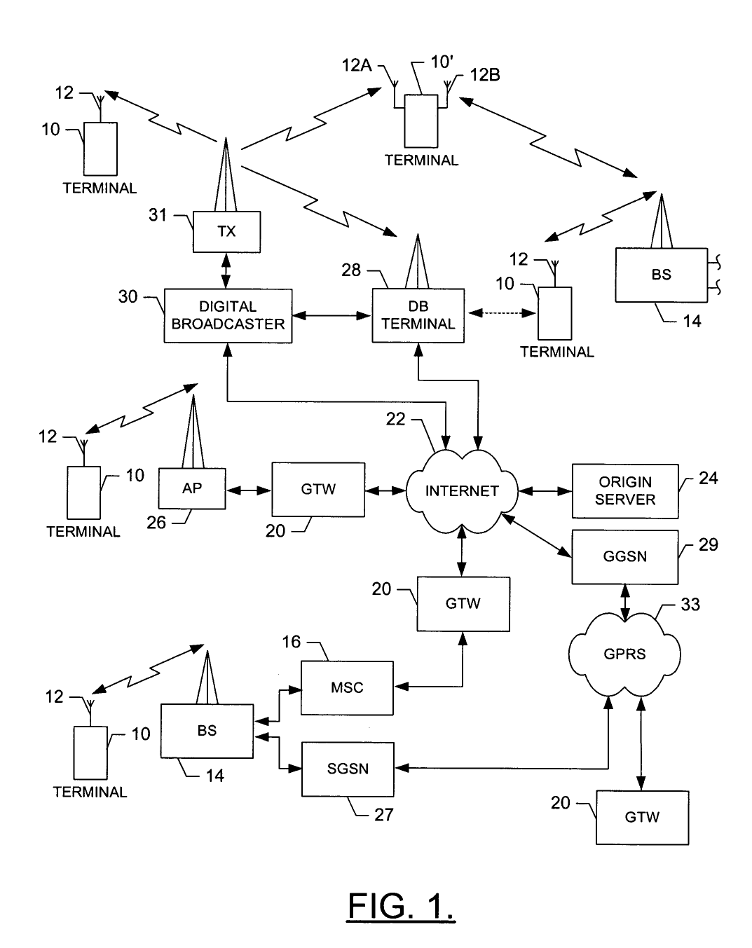

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI). In operation, the MSC is capable of routing calls and messages to and from the terminal when the terminal is making and receiving calls. The MSC also provides a connection to landline trunks when the terminal is involved in a call. Further, the MSC can be coupled to a server gateway (GTW) 20.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the terminal 10 via the Internet. For example, as explained below, the processing elements can include one or more processing elements associated with an origin server 24, one of each being illustrated in FIG. 1. In addition to the MSC 16, the BS 14 can be coupled to a signaling GPRS (General Packet Radio Service) support node (SGSN) 27. As known to those skilled in the art, the SGSN is typically capable of performing functions similar to the MSC 16 for packet switched services. The SGSN, like the MSC, can be coupled to a data network, such as the Internet 22. The SGSN can be directly coupled to the data network. In a more typical embodiment, however, the SGSN is coupled to a packet-switched core network, such as a GPRS core network 33. The packet-switched core network is then coupled to another GTW, such as a GTW GPRS support node (GGSN) 29, and the GGSN is coupled to the Internet. In addition to the GGSN, the packet-switched core network can also be coupled to a GTW 20.

By coupling the SGSN 27 to the GPRS core network 33 and the GGSN 29, devices such as origin servers 24 can be coupled to the terminal 10 via the Internet 22, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

In addition to being coupled to the BS 14, the terminal 10 can be coupled to may be wirelessly coupled to one or more wireless access points (APs) 26. The APs can comprise access points configured to communicate in accordance techniques such as, for example, radio frequency (RF), Bluetooth (BT), infrared (IrDA) or any of a number of different wireless networking techniques, including WLAN techniques. The APs may be coupled to the Internet 22. Like with the MSC 16, the APs can be directly coupled to the Internet. In one advantageous embodiment, however, the APs are indirectly coupled to the Internet via a GTW 20. As will be appreciated, by directly or indirectly connecting the terminals and the origin server 24, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

Further, the terminal 10 can additionally, or alternatively, be coupled to a digital broadcaster 30 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 31, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique as well as a cellular (e.g., 1G, 2G, 2.5G, 3G, etc.) communication technique. In such an embodiment, the terminal 10′ may include an antenna 12A for receiving content from the DVB-T TX, and another antenna 12B for transmitting signals to and for receiving signals from a BS 14. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 30 via the TX 31, the terminal can be coupled to a digital broadcast (DB) receiving terminal 28 which, in turn, can be coupled to the digital broadcaster 30, such as directly and/or via the TX. In such instances, the digital broadcast receiver can comprise a DVB-T receiver, such as a DVB-T receiver in the form of a set top box. The terminal can be locally coupled to the digital broadcast receiver, such as via a personal area network. In one advantageous embodiment, however, the terminal can additionally or alternatively be indirectly coupled to the digital broadcast receiver via the Internet 22.

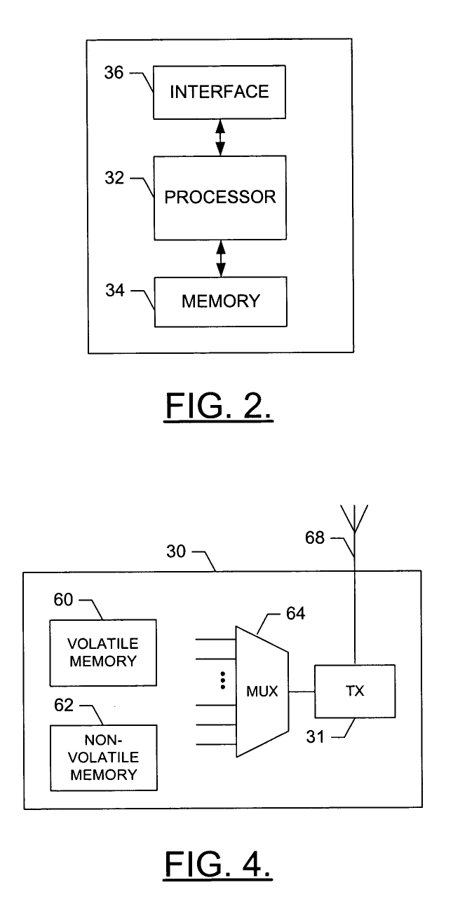

Referring now to FIG. 2, a block diagram of an entity capable of operating as a terminal 10, origin server 24, digital broadcast receiver 28, and/or a digital broadcaster 30 is shown in accordance with one embodiment of the present invention. Although shown as separate entities, in some embodiments, one or more entities may support one or more of a terminal, origin server, digital broadcast receiver, and/or a digital broadcaster, logically separated but co-located within the entit(ies). For example, a single entity may support a logically separate, but co-located, terminal and digital broadcast receiver. Also, for example, a single entity may support a logically separate, but co-located digital broadcast receiver and digital broadcaster.

As shown, the entity capable of operating as a terminal 10, origin server 24, digital broadcast receiver 28, and/or a digital broadcaster 30 can generally include a processor 32 connected to a memory 34. The processor can also be connected to at least one interface 36 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the present invention. Also, for example, the memory typically stores content transmitted from, or received by, the terminal, digital broadcast receiver, and/or digital broadcaster.

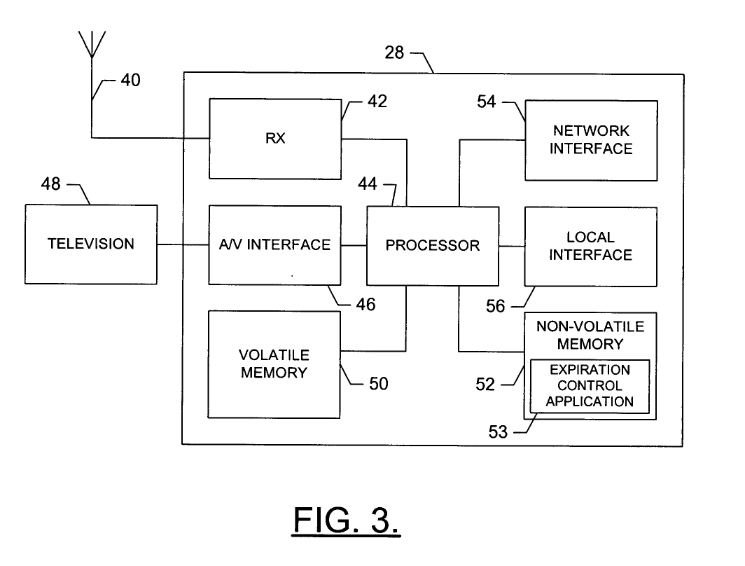

Reference is now made to FIG. 3, which illustrates a functional block diagram of a digital broadcast receiver 28, in accordance with one embodiment of the present invention. As shown, the digital broadcast receiver includes an antenna 40 for receiving signals from a digital broadcaster 30 and feeding the signals into a receiver (RX) 42. In turn, the receiver is capable of decrypting, demodulating and/or demultiplexing the signals, such as to extract content data. The receiver can feed the content data to a processor 44, which can thereafter decode the content data. The processor can then feed the decoded signal into an audio/video (A/V) interface 46, which can convert signals to a form suitable for display by a monitor, such as a television set 48.

The digital broadcast receiver 28 can include volatile memory 50, such as volatile Random Access Memory (RAM) including a cache area for the temporary storage of data. The digital broadcast receiver can also include non-volatile memory 52, which can be embedded and/or may be removable. The non-volatile memory can additionally or alternatively comprise an EEPROM, flash memory, hard disk or the like. The memories can store any of a number of pieces of information, content and data, used by the digital broadcast receiver to implement the functions of the digital broadcast receiver. For example, as indicated above, the memories can store content, such as that received from a digital broadcaster 30. As explained below, the memories can also store an expiration control application 53 capable of controlling storage of content by the digital broadcast receiver and/or a terminal 10.

The digital broadcast receiver 28 can also include one or more interface means for sharing and/or obtaining data from electronic devices, such as terminals 10 and/or digital broadcasters 30. More particularly, the digital broadcast receiver can include a network interface means 54, for sharing and/or obtaining data from a network, such as the Internet 22. For example, the digital broadcast receiver can include an Ethernet Personal Computer Memory Card International Association (PCMCIA) card configured to transmit and/or receive data to and from a network, such as the Internet.

The digital broadcast receiver 28 can also include one or more local interface means 56 for locally sharing and/or obtaining data from electronic devices, such as a terminal. For example, the digital broadcast receiver can include a radio frequency transceiver and/or an infrared (IR) transceiver so that data can be shared with and/or obtained in accordance with radio frequency and/or infrared transfer techniques. Additionally, or alternatively, for example, the digital broadcast receiver can include a Bluetooth (BT) transceiver operating using Bluetooth brand wireless technology developed by the Bluetooth Special Interest Group such that the digital broadcast receiver can share and/or obtain data in accordance with Bluetooth transfer techniques. Further, the digital broadcast receiver can additionally or alternatively be capable of sharing and/or obtaining data in accordance with any of a number of different wireline and/or wireless networking techniques, including LAN and/or WLAN techniques.

Reference is now made to FIG. 4, which illustrates a functional block diagram of the digital broadcaster 30 of one embodiment of the present invention. Like the digital broadcast receiver 28, the digital broadcaster can include volatile memory 60, such as volatile Random Access Memory (RAM) including a cache area for the temporary storage of data. The digital broadcaster can also include non-volatile memory 62, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels.

The digital broadcaster 30 can also include a multiplexer 64, which can be capable of multiplexing content for a number of television, radio and/or data channels. The multiplexer can then feed the resulting signal into a TX 31, which can be separate from the digital broadcaster, as shown in FIG. 1, or incorporated within the digital broadcaster, as shown in FIG. 4. Irrespective of where the TX is located relative to the digital broadcaster, the TX can receive the signal from the multiplexer for encryption, modulation, amplification and/or transmission, such as via an antenna 68. In this regard, for example, the digital broadcaster can be capable of directly or indirectly transmitting content to a digital broadcast receiver 28 and/or a terminal 10, such as in accordance with a digital broadcasting technique, such as DVB-T. For information on DVB-T, see European Telecommunications Standards Institute (ETSI) Standard EN 300 744, entitled: Digital Video Broadcasting (DVB): Framing structure, channel coding and modulation for digital terrestrial television, v.1.1.2 (1997) and related specifications, the contents of which are hereby incorporated by reference in their entirety.

In accordance with a number of digital broadcasting techniques, such as DVB-T, Internet Protocol (IP) Datacast (IPDC) can be utilized to provide audio, video and/or other content to terminals 10. In this regard, the digital broadcaster 30 can be capable of providing IP datacasting content to the terminal utilizing a digital broadcasting technique. As will be appreciated by those skilled in the art, digital broadcasting techniques such as DVB-T are essentially cellular in nature with a transmission site associated with each of a number of different cells. DVB-T, for example, uses MPEG-2 transport streams, and as such, IP data can be encapsulated into DVB transmission signals sent from the digital broadcaster, or more particularly the TX 31. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically unidirectional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

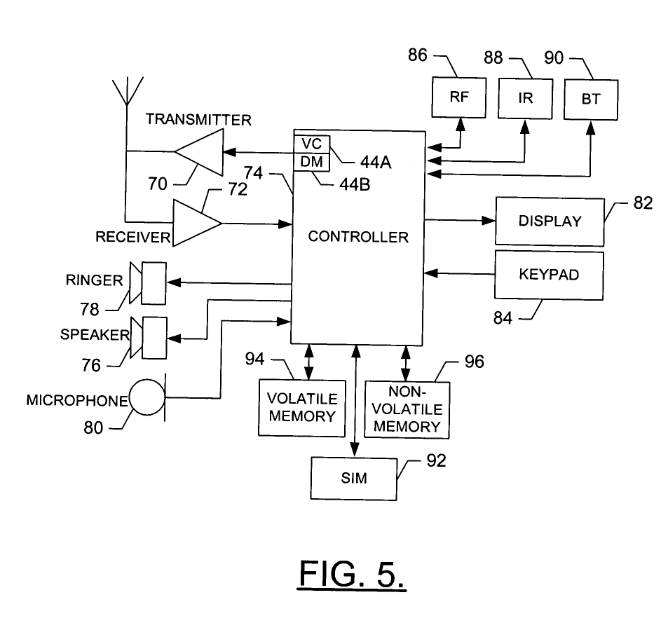

FIG. 5 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 70, a receiver 72, and a controller 74 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74A, and may include an internal data modem (DM) 74B. Further, the controller may include the functionally to operate one or more software applications, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 24, an AP 26, a digital broadcast receiver 28, a digital broadcaster 30 or the like, in accordance with any of a number of different wireline and/or wireless techniques. For example, the mobile station can include a radio frequency (RF) transceiver 86 and/or an infrared (IR) transceiver 88 such that the mobile station can share and/or obtain data in accordance with radio frequency and/or infrared techniques. Also, for example, the mobile station can include a Bluetooth (BT) transceiver 90 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 10′, the mobile station may include an additional antenna or the like to transmit and/or receive data from such electronic devices (e.g., digital broadcaster).

The mobile station can further include memory, such as a subscriber identity module (SIM) 92, a removable user identity module (R-UIM) or the like, which typically stores information elements related to a mobile subscriber. In addition to the SIM, the mobile station can include other memory. In this regard, like the digital broadcast receiver 28 and the digital broadcaster 30, the mobile station can include volatile memory 94. Also, again like the digital broadcast receiver and the digital broadcaster, the mobile station can include other non-volatile memory 96, which can be embedded and/or may be removable. The memories can store any of a number of pieces of information, and data, used by the mobile station to implement the functions of the mobile station. For example, the memories can store content, such as that received from an origin server 24 and/or a digital broadcast receiver. Also, for example, the memories can also store user or host applications such as a conventional Web browser for communicating in accordance with the hypertext transfer protocol (HTTP), a file transfer (e.g., FTP) application, a Telnet application, a peer-to-peer access application, or the like.

As explained in the background section, terminals 10 are generally capable of storing only a limited amount of data. And as such, the ability of digital broadband data broadcast techniques (e.g., DVB-T) to deliver a large amount of data at a high bit rate to a terminal can place a heavy storage capacity burden on the terminal. This is especially the case when multiple pieces of content are delivered to the mobile terminal, with the user desiring to view the different pieces of content at different times. Embodiments of the present invention are therefore capable of controlling content storage in the digital broadcast receiver 28 and/or the terminal. To facilitate control of content storage in accordance with embodiments of the present invention, content delivered to and stored by the digital broadcast receiver 28 and/or the terminal 10, such as from the digital broadcaster 30, includes a set of one or more parameters.

For example, each piece of content can include a server expiration time, a client expiration time and/or a deletion priority value. The server expiration time comprises an absolute and/or relative time that typically defines a minimum period of time the digital broadcast receiver 28, i.e., the server, stores a respective piece of content. For example, the server expiration time can comprise an absolute time, such as 4:00 PM, Oct. 2, 2003. Also, for example, the server expiration time can comprise a relative time, such as five days. The client expiration time, similar to the server expiration time, comprises an absolute or relative time that typically defines a minimum period of time the terminal 10, i.e., the client, stores a respective piece of content.

The deletion priority value typically comprises a measure of priority of a piece of content to deletion from memory (e.g., non-volatile memory 52) of the digital broadcast receiver 28 and/or memory (e.g., non-volatile memory 96) of the terminal 10. In this regard, the measure of priority comprises a measure of priority of the respective piece of content relative to other pieces of content. Based upon the server expiration, client expiration and/or deletion priority value, then, the digital broadcast receiver 28 can maintain the content in, or delete the content from, memory.

More particularly, to control storage of content at the digital broadcast receiver 28 and/or the terminal 10, a network entity is capable of operating an expiration control application 53. In this regard, the network entity can comprise any of a number of different entities capable of communicating with the digital broadcast receiver and/or the terminal. For example, the network entity can comprise the digital broadcast transmitter (e.g., TX 31), a digital broadcast receiver (e.g., DB receiver 28) or the terminal. Alternatively, for example, the network entity can comprise another entity, such as an origin server 24.

Irrespective of the network entity operating the expiration control application 53, the expiration control application can control storage of content, or more particularly the deletion of content, at the digital broadcast receiver 28 and/or the terminal 10 based upon one or more parameters (e.g., server expiration, client expiration and/or deletion priority value) associated with each piece of content. As described herein, the expiration control application typically comprises software capable of being stored within memory (e.g., non-volatile memory 52), and operated by a processor (e.g., processor 44), of the digital broadcast receiver or the terminal. It should be understood, however, that the expiration control application can alternatively comprise firmware or hardware, without departing from the spirit and scope of the present invention.

As also described herein, a network entity is capable of operating the expiration control application 53 to control the storage of content, such as content received from a digital broadcaster 30. It should be understood, however, that the expiration control application can equally be operated to control storage of content from other content sources, such as other terminals 10 and/or an origin server 24. Further, as explained above, it should be understood that the expiration control application can equally be operated by a digital broadcaster, terminal or other device, server or the like to control storage of content in accordance with embodiments of the present invention.

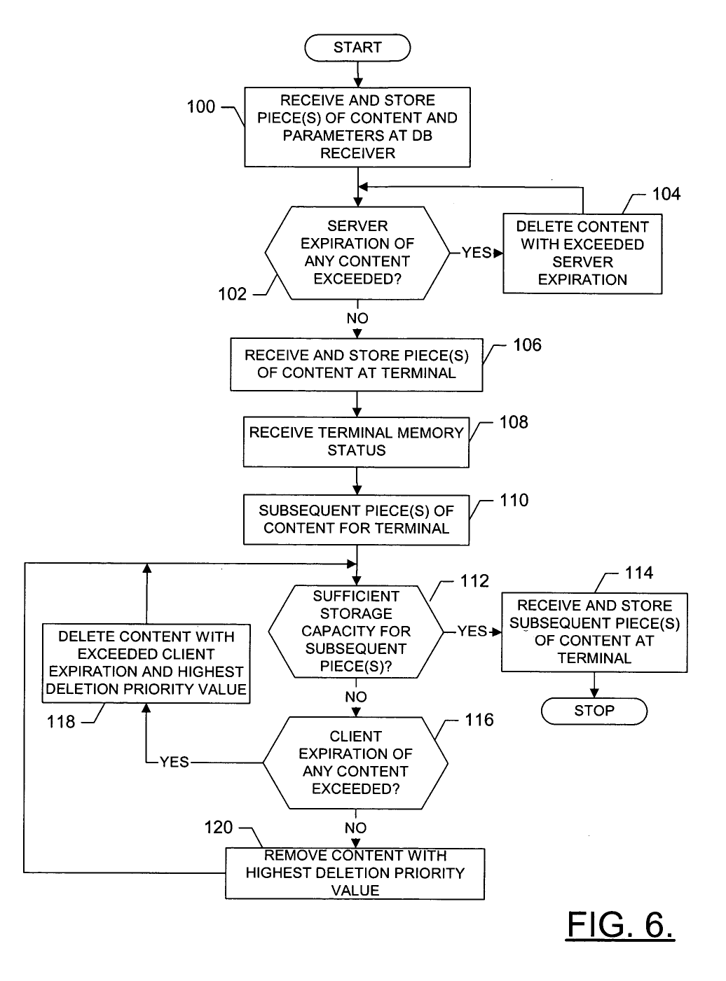

Reference is now made to FIG. 6, which illustrates various steps in a method of controlling storage of content in accordance with one embodiment of the present invention. As shown in block 100, a method of controlling storage of content generally includes receiving and storing one or more pieces of content at the digital broadcast receiver 28, such as from the digital broadcaster 30. In accordance with embodiments of the present invention, content can include one or more associated parameters. As indicated above, the piece(s) of content can comprise any of a number of different pieces of content, such as content for one or more television, radio and/or data channels. And as also indicated above, the parameters can include, for example, a server expiration time, a client expiration time and/or a deletion priority value.

After the digital broadcast receiver 28 stores the content, and as the digital broadcast receiver maintains one or more pieces of content in memory, the digital broadcast receiver, or more particularly the expiration control application 53, can monitor the piece(s) of content stored in memory (e.g., non-volatile memory 52) of the digital broadcast receiver. In this regard, as shown in block 102, the expiration control application can monitor the server expiration time(s) of the piece(s) of content stored in memory of the digital broadcast receiver. By monitoring the server expiration time(s), the expiration control application can determine if the server expiration time of any one or more pieces of stored content has been exceeded. For example, when the server expiration time comprises an absolute time, the expiration control application can determine if the current time is after the server expiration time. Also, for example, when the server expiration time comprises a relative time, the expiration control application can determine if the time between storing the respective piece of content and the current time is greater than the relative time. In this regard, the digital broadcast receiver can store the time at which the digital broadcast receiver stores or otherwise receives each piece of content, such as for subsequent comparison purposes.

If the expiration control application 53 determines that the server expiration time of one or more pieces of content stored in memory (e.g., non-volatile memory 52) of the digital broadcast receiver 28 has been exceeded, the expiration control application can instruct the digital broadcast receiver to delete or otherwise remove the respective piece(s) of content from memory of the digital broadcast receiver, as shown in block 104. Alternatively, the expiration control application can instruct the digital broadcast receiver to overwrite the respective piece(s) of content from memory of the digital broadcast receiver as necessary upon receipt of subsequent piece(s) of content, such as from the digital broadcaster 30. By deleting from memory those piece(s) of content that have an exceeded server expiration time, or allowing those piece(s) of content that have an exceeded server expiration time to be overwritten in memory, the expiration control application can control storage of content in memory of the digital broadcast receiver.

In addition to, or in lieu of, controlling storage of content in memory of the digital broadcast receiver 28, the expiration control application 53 can control storage of content in memory (e.g., non-volatile memory 96) of the terminal 10. In this regard, after the digital broadcast receiver receives one or more pieces of content, or more typically after the digital broadcast receiver stores one or more pieces of content, the digital broadcast receiver can transmit or otherwise send one or more pieces of the stored content to the terminal, as shown in block 106. Alternatively, as shown in FIG. 1, the terminal can be capable of receiving one or more pieces of content directly from the digital broadcaster 30. Irrespective of how the terminal receives the piece(s) of content, upon receipt of the piece(s) of content, the terminal can store the content, such as into non-volatile memory.

At one or more points in time, the terminal 10 can send a memory status to the expiration control application 53, as shown at block 108. For example, the terminal can be triggered, such as by the expiration control application 53, to send a memory status to the expiration control application 53. Additionally or alternatively, for example, the terminal can be configured to periodically send a memory status to the expiration control application 53. Further, for example, the terminal can be configured to send a memory status to the expiration control application 53 when the memory capacity of the terminal changes, such as in response to the terminal deleting or otherwise removing one or more piece(s) of content from memory. Irrespective of when and how often the expiration control application 53 receives a memory status, the memory status can include any of a number of different pieces of information regarding the memory of the terminal and the contents stored therein. For example, the memory status can include information regarding the remaining storage capacity of the memory of the terminal. In addition, for example, the memory status can include information regarding the pieces of content stored in memory, including one or more parameters of the set of parameters for each of the pieces of content, the time that the terminal received or otherwise downloaded each piece of content, and/or the time and/or manner that the terminal utilized each piece of content.

As will be appreciated, also at one or more points in time, the digital broadcast receiver 28 may desire to transmit or otherwise send one or more subsequent pieces of content to the terminal 10. Additionally, or alternatively, at one or more pieces of time, the terminal may desire to download or otherwise receive one or more subsequent pieces of content from the digital broadcast receiver. Irrespective of whether the digital broadcast receiver desires to transmit subsequent piece(s) of content to the terminal, or whether the terminal desires to download subsequent piece(s) of content from the digital broadcast receiver, at one or more points in time, the digital broadcast receiver can have stored, in memory, subsequent piece(s) of content to transmit or otherwise send to the terminal, as shown in block 110. In such instances, the expiration control application 53 can determine if memory (e.g., non-volatile memory 96) of the terminal has sufficient storage capacity to store the subsequent piece(s) of content, as shown in block 112.

The expiration control application 53 can determine if memory (e.g., non-volatile memory 96) of the terminal 10 has sufficient storage capacity to store subsequent piece(s) of content in any of a number of different manners. However, the expiration control application typically determines whether the terminal has sufficient storage capacity based upon the size of the subsequent piece(s) of content and the remaining storage capacity in memory of the terminal, which can be determined from information in the memory status from the terminal. As shown in block 114, if the expiration control application determines that the memory of the terminal does have sufficient storage capacity, the digital broadcast receiver 28 can transmit or otherwise send the subsequent piece(s) of content to the terminal. Upon receipt of the subsequent piece(s) of content, then, the terminal can store the content into memory. Thereafter, the digital broadcast receiver can, but need not, delete the subsequent piece(s) of content, or allow the subsequent piece(s) of content to be overwritten in memory of the digital broadcast receiver.

If the expiration control application 53 determines that memory of the terminal 10 does not have sufficient storage capacity, the expiration control application can determine if the client expiration time of any one or more pieces of content stored in memory of the terminal has been exceeded, as shown in block 116. The expiration control application can determine if the client expiration time of any piece(s) of content stored in memory of the terminal has been exceeded in any of a number of different manners. For example, the expiration control application can determine if any piece(s) of content have an exceeded client expiration time in the same manner as the expiration control application determines if the server expiration time of any piece(s) of content stored in memory of the digital broadcast receiver 28 have been exceeded, as explained above. In this regard, for example, the expiration control application can determine the piece(s) of content stored in memory of the terminal, and one or more parameters of the set of parameters for each of the piece(s) of content, from the memory status received from the terminal.

If the expiration control application 53 determines that the client expiration time of one or more piece(s) of content stored in memory (e.g., non-volatile memory 96) of the terminal 10 has been exceeded, the expiration control application can identify the piece of content having the highest deletion priority value from among those piece(s) of content with an exceeded client expiration time. After identifying the piece of content having the highest deletion priority value, the expiration control application can instruct the terminal or a user of the terminal to delete or otherwise remove the respective piece of content from memory, as shown in block 118. Thereafter, the expiration control application can again determine if memory of the terminal has sufficient storage capacity to store subsequent piece(s) of content (see block 112). If the expiration control application determines that the memory of the terminal does have sufficient storage capacity, the digital broadcast receiver 28 can transmit or otherwise send the subsequent piece(s) of content to the terminal (see block 114).

If the expiration control application 53 again determines that the memory of the terminal 10 does not have sufficient storage capacity, however, the expiration control application can again identify, from the piece(s) of content remaining in memory of the terminal, the piece of content having an exceeded client expiration time and the highest deletion priority value. After identifying such a piece of content, the expiration control application can instruct the terminal or a user of the terminal to delete or otherwise remove the respective piece of content from memory (see block 118). The method can then repeatedly continue until either the memory of the terminal gains sufficient storage capacity and the subsequent piece(s) of content are transmitted to the terminal, or the expiration control application determines that the memory of the terminal does not include any piece of content having an exceeded client expiration time. As such, by deleting the piece(s) of content in sequential order of the deletion priority value, not all of the pieces of content having exceeded client expiration times need be immediately deleted from memory of the terminal for the terminal to receive the subsequent piece(s) of content. In this regard, the deletion priority value is typically set with the highest priorities assigned to the pieces of content that should be first deleted, and the lowest priorities assigned to the pieces of content that should be retained the longest.

If the expiration control application 53 determines that the memory of the terminal 10 does not have sufficient storage capacity for the subsequent piece(s) of content, but the memory of the terminal does not include any piece of content having an exceeded client expiration time to delete from memory, the terminal can inform the digital broadcast receiver 28 that the terminal does not have sufficient storage capacity to receive the subsequent piece(s) of content. In one advantageous embodiment, however, the expiration control application can turn to the remaining piece(s) of content stored in memory of the terminal that do not have an exceeded client expiration time. In this regard, the expiration control application can identify the piece of content having the highest deletion priority value from among those remaining piece(s) of content in memory of the terminal. After identifying the piece of content having the highest deletion priority value, the expiration control application can instruct the terminal or a user of the terminal to delete or otherwise remove the respective piece of content from memory, as shown in block 120. Thereafter, as before, the expiration control application can again determine if memory of the terminal has sufficient storage capacity to store subsequent piece(s) of content (see block 112). If the expiration control application determines that memory of the terminal does have sufficient storage capacity, the digital broadcast receiver can transmit or otherwise send the subsequent piece(s) of content to the terminal (see block 114).

If the expiration control application 53 again determines that the memory of the terminal does not have sufficient storage capacity, however, the expiration control application can again identify, from the piece(s) of content remaining in memory of the terminal 10, the piece of content having the highest deletion priority value. After identifying such a piece of content, the expiration control application can instruct the terminal or a user of the terminal to delete or otherwise remove the respective piece of content from memory (see block 120). The method can then repeatedly continue until the memory of the terminal gains sufficient storage capacity and the subsequent piece(s) of content are transmitted to the terminal (see block 114).

The expiration control application 53 of the digital broadcast receiver 28 can therefore control storage of content in memory (e.g., non-volatile memory 52, 96) of the digital broadcast receiver and/or the terminal 10 based upon parameters associated with each piece of content. More particularly, the expiration control application can control storage of content in memory of the digital broadcast receiver by deleting from memory those piece(s) of content that have an expired storage time. Likewise, the expiration control application can control storage of content in memory of the terminal by deleting those piece(s) of content that have an expired storage time in memory of the terminal and/or a higher deletion priority value. Thus, the terminal can be capable of receiving one or more pieces of content at different times for viewing at a time subsequent to receiving the content, while placing a reduced burden on the storage capacity of the terminal.

As explained above, when the expiration control application 53 determines that the memory of the terminal 10 does not have sufficient storage capacity for the subsequent piece(s) of content, but the memory of the terminal does not include any piece of content having an exceeded client expiration time to delete from memory, the expiration control application can delete one or more pieces of content from among those remaining in memory of the terminal in sequential order of the deletion priority value. It should be understood, however, that in various instances it may be desirable to avoid deleting one or more pieces of content to thereby store the subsequent piece(s) of data. For example, in various instances, one or more pieces of content in memory of the terminal may have a higher deletion priority value than one or more of the subsequent piece(s) of content. As such, in accordance with one embodiment, before deleting one or more pieces of content from among those remaining in memory of the terminal in sequential order of the deletion priority value, the expiration control application can, but need not, compare the deletion priority value(s) of the subsequent piece(s) of content to the deletion priority value(s) of the piece(s) of content remaining in memory. The expiration control application can therefore only instruct the terminal to delete piece(s) of content from memory if those pieces of content have a deletion priority value higher than the deletion priority value(s) of the subsequent piece(s) of content.

As also explained above, the expiration control application 53 is capable of deleting content from memory of the digital broadcast receiver 28 and/or the terminal 10 based upon parameters associated with respective pieces of content. It should be understood, however, that the parameters can alternatively prohibit that the expiration control application from deleting one or more respective pieces of content. In this regard, one or more pieces of content can have an unlimited server and/or client expiration time, and/or can have a deletion priority value prohibiting the expiration control application from instructing the digital broadcast receiver and/or terminal from deleting the respective piece(s) of content. Such parameters, as well as one or more of the other parameters, can be associated with the respective piece(s) of content at the digital broadcaster 30. Additionally, or alternatively, the parameters can be associated with the respective piece(s) of content, or associated parameters can be deleted, modified or the like at the digital broadcast receiver and/or terminal, such as based upon user input.

As explained above, to facilitate control of content storage in accordance with embodiments of the present invention, content delivered to and stored by the digital broadcast receiver 28 and/or the terminal 10 includes a set of one or more parameters. It should be understood, however, that the set of parameter(s) can be associated with the respective piece(s) of content in any of a number of different manners, at any of a number of different times, and at any of a number of different locations. For example, as described above, the piece(s) of content can be stored with associated set(s) of parameter(s), where the parameters can be associated with the content at a source of the content (e.g., digital broadcaster 30). Alternatively, for example, the digital broadcast receiver 28 and/or the terminal 10 can receive the piece(s) of content without associated parameters. After receiving the content, then, the digital broadcast receiver and/or the terminal can associate one or more parameters with each piece of content. As will be appreciated, the digital broadcast receiver and/or the terminal need not associate all of the associated parameters for each piece of content. For example, the digital broadcast receiver can associate one or more parameters for the piece(s) of content, with the terminal (or a user of the terminal) subsequently setting the deletion priority value for one or more of the piece(s) of content.

In yet another alternative example, the digital broadcast receiver 28 and terminal 10 can receive and store the piece(s) of content without associated parameters. Then, before or as the expiration control application 53 monitors the piece(s) of content stored in memory (e.g., non-volatile memory 52) of the digital broadcast receiver, or after the expiration control application receives the memory status from the terminal, the expiration control application can associate one or more parameters with each piece of content. In this regard, particularly if the expiration control application associates the parameter(s) with the piece(s) of content, the expiration control application can be capable of associating the parameter(s) based upon information included in the memory status, such as an identifier of the piece(s) of content. Thus, the parameter(s) can be stored by the expiration control application, separate from the piece(s) of content.

According to one aspect of the present invention, all or a portion of the system of the present invention, such all or portions of the terminal 10, digital broadcast receiver 28, and/or a digital broadcaster 30, generally operates under control of a computer program product (e.g., expiration control application 53). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 6 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart supports combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system of controlling storage of content in memory, the system comprising:
a network entity comprising an expiration control application capable of receiving astatus of a at least one piece of content stored in memory of a terminal, wherein each piece of content is associated with at least one parameter including at least one of a client expiration time and a deletion priority value, and wherein the network entity is also capable of controlling storage of content in memory of the terminal based upon the status and the at least one associated parameter.

2. A system according to claim 1, wherein the expiration control application is capable of determining if memory of the terminal has sufficient storage capacity for at least one subsequent piece of content, and if memory does not have sufficient storage capacity, instructing at least one of the terminal and a user of the terminal to delete at least one piece of content based upon the deletion priority value of each piece of content stored in memory of the terminal.

3. A system according to claim 2, wherein the expiration control application is capable of determining at least one piece of content having an exceeded client expiration time, identifying a piece of content having a highest deletion priority value from the at least one piece of content having an exceeded client expiration time, and instructing the terminal to delete the identified piece of content.

4. A system according to claim 3, wherein the expiration control application is capable of repeatedly identifying a piece of content, and instructing the terminal to delete the identified piece of content, until one of memory of the terminal has sufficient storage capacity for the at least one subsequent piece of content, and each piece of content having an exceeded client expiration time has been identified and deleted.

5. A system according to claim 4, wherein when memory of the terminal does not have sufficient storage capacity for at least one subsequent piece of content and each piece of content having an exceeded client expiration time has been identified and deleted, the expiration control application is further capable of identifying at least one piece of content having a highest deletion priority value from at least one piece of content remaining in memory of the terminal, and instructing the terminal to delete the identified at least one piece of content.

6. A system according to claim 1, wherein the network entity is capable of storing at least one piece of content, wherein the at least one parameter further includes a server expiration time, and wherein the network entity is capable of sending at least one piece of content to the terminal.

7. A system according to claim 6, wherein the expiration control application is further capable of monitoring the server expiration time of the at least one piece of content in memory of the network entity to determine if at least one piece of content has an exceeded server expiration time, and if at least one piece of content has an exceeded server expiration time, instructing the network entity to delete the at least one piece of content having an expired server expiration time.

8. A system according to claim 1 further comprising:
a terminal capable of sending the status of at least one piece of content stored in memory of the terminal such that the network entity can control the storage of content in memory of the terminal.

9. A system according to claim 8, wherein the terminal is capable of associating each piece of content stored in memory of the terminal with at least one parameter.

10. A system according to claim 9, wherein the terminal is capable of setting a deletion priority value for at least one piece of content.

11. A system according to claim 1, wherein the network entity is capable of associating each piece of content stored in memory of the terminal with at least one parameter.

12. A terminal for controlling storage of content in memory, the terminal comprising:
a memory capable of storing at least one piece of content, wherein each piece of content is associated with at least one parameter including at least one of a client expiration time and a deletion priority value; and
a controller capable of sending a status of the at least one piece of content stored in memory such that storage of the at least one piece of content in memory can be controlled based upon the status and the at least one parameter.

13. A terminal according to claim 12, wherein the memory is capable of storing the at least one piece of content such that it can be determined if the memory has sufficient storage capacity for at least one subsequent piece of content, and if the memory does not have sufficient storage capacity, the controller can delete at least one piece of content based upon the deletion priority value of each piece of content stored in memory.

14. A terminal according to claim 13, wherein the controller is capable of sending a status of the at least one piece of content such that at least one piece of content can be determined to have an exceeded client expiration time, and wherein the controller is capable of deleting a piece of content having a highest deletion priority value from the at least one piece of content having an exceeded client expiration time.

15. A terminal according to claim 14, wherein the controller is capable of repeatedly deleting a piece of content having a highest deletion priority value from the at least one piece of content having an exceeded client expiration time until one of memory of the terminal has sufficient storage capacity for the at least one subsequent piece of content, and each piece of content having an exceeded client expiration time has been identified and deleted.

16. A terminal according to claim 15, wherein when the memory does not have sufficient storage capacity for at least one subsequent piece of content and each piece of content having an exceeded client expiration time has been identified and deleted, the controller is capable of deleting at least one piece of content having a highest deletion priority value from at least one piece of content remaining in memory of the terminal.

17. A terminal according to claim 12, wherein the controller is capable of associating each piece of content stored in the memory with at least one parameter.

18. A terminal according to claim 17, wherein the controller is capable of setting a deletion priority value for at least one piece of content.

19. A method of controlling storage of content in memory, the method comprising:
receiving a status of at least one piece of content stored in memory of a terminal, wherein each piece of content is associated with at least one parameter including at least one of a client expiration time and a deletion priority value; and
controlling storage of content in memory of the terminal based upon the status and the at least one parameter associated with each of the at least one piece of content.

20. A method according to claim 19, wherein controlling storage of content in memory of the terminal comprises:
determining if memory of the terminal has sufficient storage capacity for at least one subsequent piece of content; and if memory does not have sufficient storage capacity,
deleting at least one piece of content based upon the deletion priority value of each piece of content stored in memory of the terminal.

21. A method according to claim 20, wherein deleting at least one piece of content comprises:
determining at least one piece of content having an exceeded client expiration time; and
identifying, and thereafter deleting, a piece of content having a highest deletion priority value from the at least one piece of content having an exceeded client expiration time.

22. A method according to claim 21, wherein identifying, and thereafter deleting, a piece of content comprise repeatedly identifying, and thereafter deleting, a piece of content until one of memory of the terminal has sufficient storage capacity for the at least one subsequent piece of content, and each piece of content having an exceeded client expiration time has been identified and deleted.

23. A method according to claim 22, wherein when memory of the terminal does not have sufficient storage capacity for at least one subsequent piece of content and each piece of content having an exceeded client expiration time has been identified and deleted, the method further comprises:
identifying, and thereafter deleting, a piece of content having a highest deletion priority value from at least one piece of content remaining in memory of the terminal.

24. A method according to claim 19 further comprising:
receiving at least one piece of content at a network entity; and
sending at least one piece of content to the terminal such that the terminal receives, and thereafter stores, the at least one piece of content.

25. A method according to claim 24, wherein the at least one parameter further includes a server expiration time, and wherein the method further comprises:
monitoring the server expiration time of the at least one piece of content in memory of the network entity to determine if at least one piece of content has an exceeded server expiration time; and if at least one piece of content has an exceeded server expiration time,
deleting the at least one piece of content having an expired server expiration time.

26. A method according to claim 19 further comprising:
associating each piece of content stored in memory of the terminal with at least one parameter.

27. A method according to claim 26, wherein associating each piece of content comprises setting a deletion priority value for at least one piece of content at the terminal.

28. A method according to claim 26, wherein associating each piece of content comprises associating each piece of content stored in memory of the terminal with at least one parameter at a network entity capable of controlling storage of content in memory of the terminal.

29. A computer program product for controlling storage of content in memory, the computer program product comprising a computer-readable storage medium having computer-readable program code portions stored therein, the computer-readable program code portions comprising:
a first executable portion for receiving a status of at least one piece of content stored in memory of a terminal, wherein each piece of content is associated with at least one parameter including at least one of a client expiration time and a deletion priority value; and
a second executable portion for controlling storage of content in memory of the terminal based upon the status and the at least one parameter associated with each of the at least one piece of content.

30. A computer program product according to claim 29, wherein the second executable portion is adapted to determine if memory of the terminal has sufficient storage capacity for at least one subsequent piece of content, and if memory does not have sufficient storage capacity, instructing at least one of the terminal and a user of the terminal to delete at least one piece of content based upon the deletion priority value of each piece of content stored in memory of the terminal.

31. A computer program product according to claim 30, wherein the second executable portion is adapted to determine at least one piece of content having an exceeded client expiration time, identify a piece of content having a highest deletion priority value from the at least one piece of content having an exceeded client expiration time, and instruct the terminal to delete the identified piece of content.

32. A computer program product according to claim 31, wherein the second executable portion is adapted to repeatedly identify a piece of content, and instruct the terminal to delete the identified piece of content, until one of memory of the terminal has sufficient storage capacity for the at least one subsequent piece of content, and each piece of content having an exceeded client expiration time has been identified and deleted.

33. A computer program product according to claim 32, wherein when memory of the terminal does not have sufficient storage capacity for at least one subsequent piece of content and each piece of content having an exceeded client expiration time has been identified and deleted, the computer program product further comprises:
a third executable portion for identifying, and thereafter instructing the terminal to delete, a piece of content having a highest deletion priority value from at least one piece of content remaining in memory of the terminal.

34. A computer program product according to claim 30 further comprising:
a third executable portion for receiving at least one piece of content at a network entity; and
a fourth executable portion for sending at least one piece of content to the terminal such that the terminal receives, and thereafter stores, the at least one piece of content.

35. A computer program product according to claim 34, wherein the at least one parameter further includes a server expiration time, and wherein the computer program product further comprises:
a fifth executable portion for monitoring the server expiration time of the at least one piece of content in memory of the network entity to determine if at least one piece of content has an exceeded server expiration time, and if at least one piece of content has an exceeded server expiration time, deleting the at least one piece of content having an expired server expiration time.

36. A computer program product according to claim 29 further comprising:
a third executable portion for associating each piece of content stored in memory of the terminal with at least one parameter.

37. A computer program product according to claim 36, wherein the third executable portion is adatped to set a deletion priority value for at least one piece of content at the terminal.

38. A computer program product according to claim 36, wherein the third executable portion is adapted to associating each piece of content stored in memory of the terminal with at least one parameter at a network entity capable of controlling storage of content in memory of the terminal.
